(19) United States
(12) Patent Application Publication
(10) Pub. No.: US 2026/0331388 A1
(43) Pub. Date: Oct. 22, 2026

(54) PEELING APPARATUS AND PEELING METHOD USING PEELING APPARATUS

(71) Applicant: SAMSUNG ELECTRO-MECHANICS CO., LTD., Suwon-si (KR)

(72) Inventor: Young Rae Cho, Suwon-si (KR)

(73) Assignee: SAMSUNG ELECTRO-MECHANICS CO., LTD., Suwon-si (KR)

(21) Appl. No.: 19/578,222

(22) Filed: Mar. 25, 2026

(30) Foreign Application Priority Data
Apr. 16, 2025 (KR) 10-2025-0049361

(51) Int. Cl. B32B 43/00; H01G 13/00

(52) U.S. Cl. CPC H01G 13/00

(57) ABSTRACT

A peeling apparatus includes a case accommodating a first roll and a second roll, and a peeling structure connected to the case. The peeling structure includes a connection portion connected to a protrusion portion of the case, and a cylindrical body rotatably connected to the connection portion, and the connection portion includes an elastic body having a length changing according to linear movement of the cylindrical body.

### CROSS-REFERENCE TO RELATED APPLICATION(S)

This application claims benefit of priority to Korean Patent Application No. 10-2025-0049361 filed on Apr. 16, 2025 in the Korean Intellectual Property Office, the disclosure of which is incorporated herein by reference in its entirety.

### TECHNICAL FIELD

The present disclosure relates to a peeling apparatus and a peeling method using the same.

A multilayer electronic component such as a multilayer ceramic capacitor (MLCC) may be manufactured by laminating and pressing a dielectric sheet and an internal electrode sheet to form a laminate, and then cutting the laminate to a designed size.

During such a cutting process, mechanical stress may be applied to the laminate, resulting in a risk of cracks or delamination occurring between the laminated dielectric sheet and internal electrode sheet.

When the laminate is cut, a protective film such as a carrier film may be attached to the laminate. The protective film may prevent cracks or delamination between the dielectric sheet and internal electrode sheet, enable precise cutting, and prevent contamination of the cut laminate due to contamination or static electricity generated during cutting.

After cutting of the laminate is completed and a laminated bar is formed, a process of removing the protective film, such as the carrier film, may then be performed for subsequent processes such as forming or sintering an external electrode. In the related art, in order to remove the protective film, a triangular pillar-shaped structure having an inner angle of about 30 degrees has been used. However, such a structure may increase stress applied to the laminated bar when the protective film is peeled from the laminated bar, resulting in A/C delamination of the MLCC or peeling of a cover portion.

Therefore, there is a need for an improved peeling apparatus and peeling method using the same, capable of minimizing stress applied to the laminated bar when removing the protective film such as the carrier film.

### SUMMARY

An aspect of the present disclosure is to minimize stress applied to a laminated bar when removing a protective film, such as a carrier film.

However, the aspects of the present disclosure are not limited to those set forth herein, and will be more easily understood in the course of describing specific example embodiments of the present disclosure.

According to an aspect of the present disclosure, there is provided a peeling apparatus including a case accommodating a first roll and a second roll, and a peeling structure connected to the case. The peeling structure may include a connection portion connected to a protrusion portion of the case, and a cylindrical body rotatably connected to the connection portion, and the connection portion may include an elastic body having a length that changes according to linear movement of the cylindrical body.

According to example embodiments of the present disclosure, stress applied to a laminated bar may be minimized when removing a protective film such as a carrier film.

However, the various advantages and effects of the present disclosure are not limited to those set forth herein, and will be more easily understood in the course of describing specific example embodiments of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer ceramic capacitor (MLCC);

FIG. 2 is a cross-sectional view taken along line I-I′ of FIG. 1;

FIG. 3 is a cross-sectional view taken along line II-II′ of FIG. 1;

FIG. 4 is a schematic plan view of an operation of laminating a dielectric sheet and an internal electrode to form a laminated bar;

FIG. 5 is a schematic perspective view of an operation of cutting a laminated bar;

FIG. 6 is a perspective view of a peeling apparatus according to the related art;

FIG. 7 is a schematic plan view, viewed in direction P1 of FIG. 6, of a peeling method using a peeling apparatus according to the related art;

FIG. 8 is a schematic perspective view of a peeling apparatus according to an example embodiment of the present disclosure;

FIG. 9 is a schematic plan view, viewed in direction P1 of FIG. 8, of a peeling method using a peeling apparatus according to an example embodiment of the present disclosure;

FIG. 10A is an image obtained by capturing a carrier film peeled from a laminated bar using a peeling apparatus according to the related art, and FIG. 10B is an image obtained by capturing a carrier film peeled from a laminated bar using a peeling apparatus according to an example embodiment of the present disclosure; and

FIG. 11A and FIG. 11B are graphs illustrating results of measuring peeling strength when peeling of a carrier film is performed using a peeling apparatus according to the related art, and when peeling of a carrier film is performed using a peeling apparatus according to an example embodiment of the present disclosure.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

In order to clearly illustrate the present disclosure, portions not related to the description are omitted, and sizes and thicknesses are magnified in order to clearly represent layers and regions, and similar portions having the same functions within the same scope are denoted by similar reference numerals throughout the specification. Throughout the specification, when an element is defined as “comprising” or “including,” it means that it may include other elements as well, rather than excluding other elements, unless specifically stated otherwise.

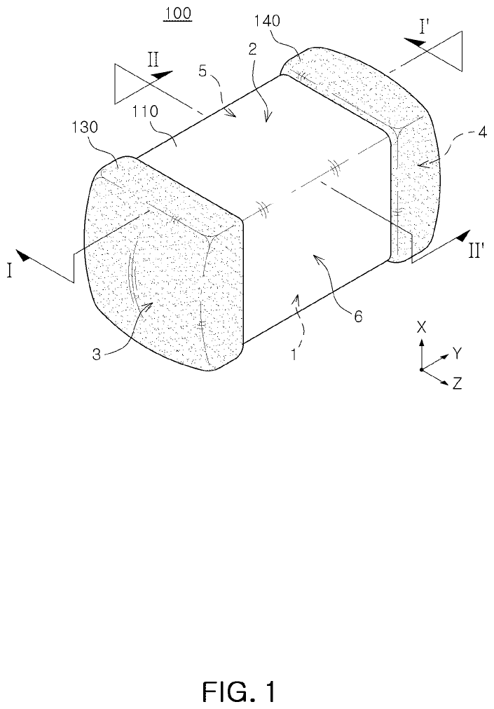

FIG. 1 is a schematic perspective view of a multilayer ceramic capacitor (MLCC).

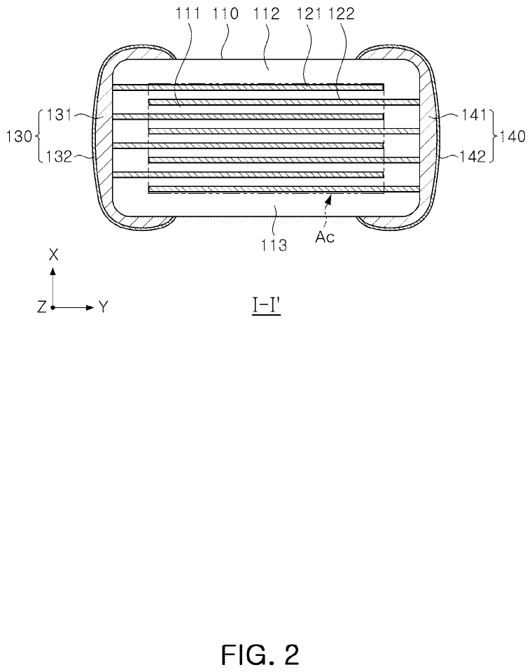

FIG. 2 is a cross-sectional view taken along line I-I′ of FIG. 1.

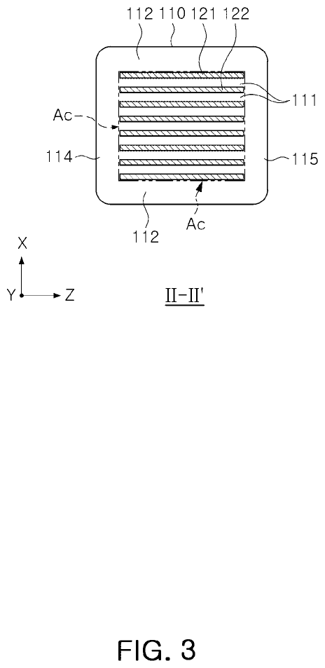

FIG. 3 is a cross-sectional view taken along line II-II′ of FIG. 1.

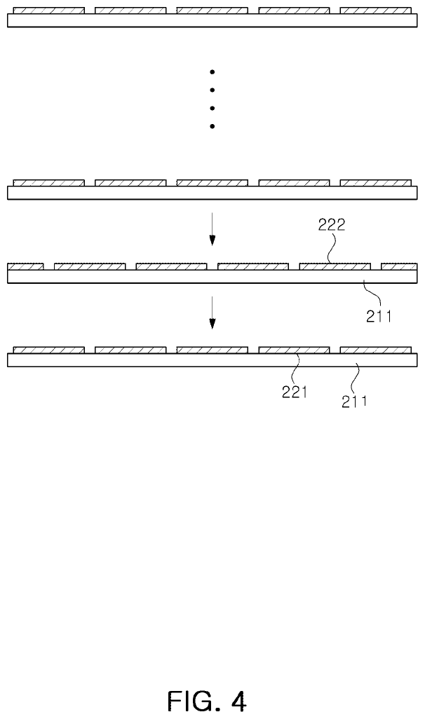

FIG. 4 is a schematic plan view of an operation of laminating a dielectric sheet and an internal electrode to form a laminated bar.

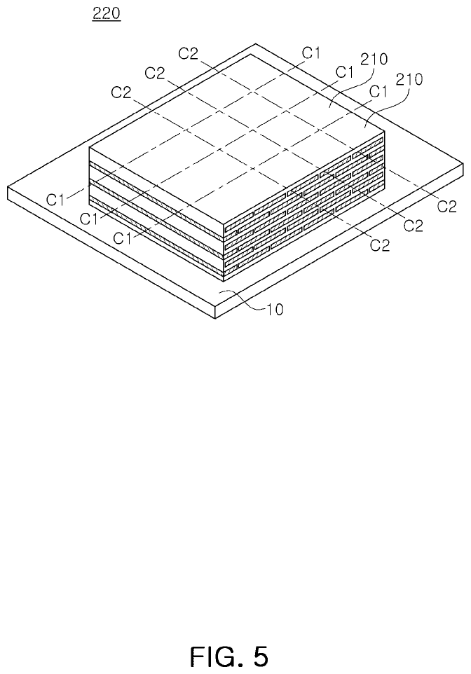

FIG. 5 is a schematic perspective view of an operation of cutting a laminated bar.

Hereinafter, before describing a peeling apparatus and a peeling method using the same according to an example embodiment of the present disclosure, a method of manufacturing an MLCC as an example of a multilayer electronic component to which the peeling apparatus and the peeling method may be applied will be described.

However, the peeling apparatus and the peeling method using the same according to an example embodiment of the present disclosure may be applied not only to a method of manufacturing an MLCC to be described below, but also to processes of peeling a film substrate such as a carrier film or a protective film in a semiconductor manufacturing process, display panel manufacturing process, solar panel manufacturing process, multilayer inductor manufacturing process, and multilayer varistor manufacturing process.

An MLCC 100 according to an example embodiment may include a body 110 including a dielectric layer 111 and internal electrodes 121 and 122, and external electrodes 130 and 140 disposed on the body 110.

Referring to FIG. 2, the body 110 may include a dielectric layer 111 including dielectric grains, internal electrodes 121 and 122, and a capacitance formation portion Ac in which the dielectric layer 111 and the internal electrodes 121 and 122 are laminated to form capacitance.

In the body 110, the dielectric layer 111 and the internal electrodes 121 and 122 may be alternately laminated.

The capacitance formation portion Ac may be a region including a first internal electrode 121 and a second internal electrode 122 disposed to oppose each other with the dielectric layer 111 interposed therebetween to form capacitance.

The dielectric layer 111, included in the body 110, may be provided as a plurality of dielectric layers 111, and may be in a sintered state. Adjacent dielectric layers 111 may be integrated with each other such that boundaries therebetween are not readily apparent without using a scanning electron microscope (SEM).

The dielectric layer 111 may be formed by preparing a dielectric slurry including ceramic powder particles, and laminating and sintering dielectric sheets using the dielectric slurry. As a material of the ceramic powder particles, a barium titanate (BaTiO₃)-based powder particles may be used. More specifically, the barium titanate (BaTiO₃)-based powder particles may include one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1).

Referring to FIG. 2, the internal electrodes 121 and 122 may be alternately laminated with the dielectric layer 111.

That is, referring to FIG. 3, the first internal electrode 121 may be connected to a first external electrode 130 without being connected to a second external electrode 140, and the second internal electrode 122 may be connected to the second external electrode 140 without being connected to the first external electrode 130. In this case, the first and second internal electrodes 121 and 122 may be electrically separated from each other by the dielectric layer 111 disposed therebetween.

A material included in the internal electrodes 121 and 122 is not limited, and a material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), or alloys thereof.

Referring to FIG. 3, the body 110 may include cover portions 112 and 113 disposed on both end surfaces of the capacitance formation portion Ac in a first direction.

Specifically, the body 110 may include a first cover portion 112 disposed on one surface of the capacitance formation portion Ac in the first direction, and a second cover portion 113 disposed on the other surface of the capacitance formation portion Ac in the first direction. More specifically, the first cover portion 112 may be disposed on an upper portion of the capacitance formation portion Ac in the first direction, and the second cover portion 113 may be disposed on a lower portion of the capacitance formation portion Ac in the first direction.

The upper cover portion 112 and the lower cover portion 113 may be formed by laminating a single dielectric layer 111 or two or more dielectric layers 111 on upper and lower surfaces of the capacitance formation portion Ac in the first direction, respectively, and may basically serve to prevent damage to the internal electrodes 121 and 122 caused by physical or chemical stress.

The upper cover portion 112 and the lower cover portion 113 may not include the internal electrodes 121 and 122, and may include a material the same as that of the dielectric layer 111. That is, the upper cover portion 112 and the lower cover portion 113 may include a ceramic material, and for example, may include a barium titanate (BaTiO₃)-based ceramic material.

Referring to FIG. 4, margin portions 114 and 115 may be disposed on both end surfaces of the body 110 in a third direction.

More specifically, the margin portions 114 and 115 may include a first margin portion 114 disposed on a fifth surface 5 of the body 110, and a second margin portion 115 disposed on a sixth surface 6 of the body 110. That is, the margin portions 114 and 115 may be disposed on both end surfaces of the body 110 in the third direction.

As illustrated, the margin portions 114 and 115 may refer to regions, based on a cross-section of the body 110 in the first and third directions, between both ends of the first and second internal electrodes 121 and 122 in the third direction and boundary surfaces of the body 110.

The margin portions 114 and 115 may basically serve to prevent damage to the internal electrodes 121 and 122 caused by physical or chemical stress.

The margin portions 114 and 115 may be formed by coating a conductive paste on a ceramic green sheet to form the internal electrodes 121 and 122, except for a portion of the ceramic green sheet on which the margin portions 114 and 115 are to be formed, cutting the laminated internal electrodes 121 and 122 to be exposed to the fifth and sixth surfaces 5 and 6 of the body 110 so as to suppress a step portion caused by the internal electrodes 121 and 122, and then laminating a single dielectric layer 111 or two or more dielectric layers 111 on both end surfaces of the capacitance formation portion Ac in the third direction.

The first margin portion 114 and the second margin portion 115 may not include the internal electrodes 121 and 122, and may include a material the same as that of the dielectric layer 111. That is, the first margin portion 114 and the second margin portion 115 may include a ceramic material, and for example, may include a barium titanate (BaTiO₃)-based ceramic material.

Referring to FIG. 1, the external electrodes 130 and 140 may be disposed on the body 110. The external electrodes 130 and 140 may be formed of any material having electrical conductivity, such as metal or the like, and a specific material may be determined in consideration of electrical characteristics, structural stability, or the like. In addition, the external electrodes 130 and 140 may have a multilayer structure.

For example, the external electrodes 130 and 140 may include electrode layers 131 and 141 disposed on the body 110, and plating layers 132 and 142 disposed on the electrode layers 131 and 141.

Referring to FIGS. 4 and 5, a method of manufacturing an MLCC 100 may include an operation of laminating and pressing a dielectric sheet 211 on which internal electrode patterns 221 and 222 are disposed to form a laminate 220.

Referring to FIG. 5, after forming the laminate 220, an operation of cutting the laminate 220 to form a laminated bar 210 may be performed. Referring to FIG. 5, a carrier film 10 may be attached to one surface of the laminate 220. Accordingly, even when the laminate 220 is cut along lines C1-C1 and C2-C2, cracks or delamination between the laminated dielectric sheets and internal electrode sheets may be suppressed.

The formed laminated bar 210 may undergo a process of removing the carrier film 10 to perform a subsequent process, such as sintering or forming an external electrode.

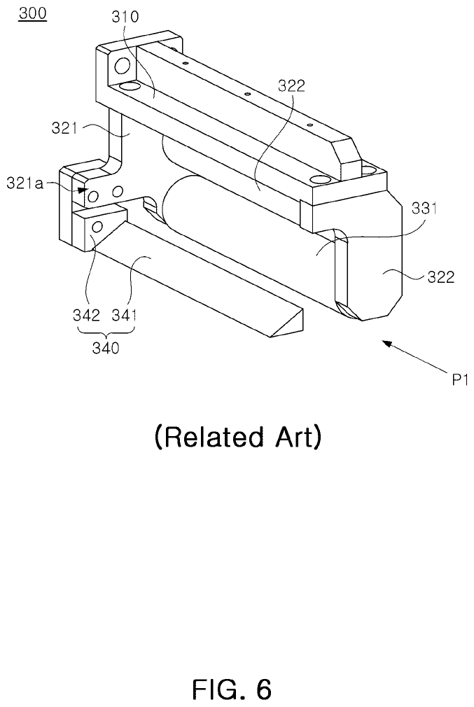

FIG. 6 is a perspective view of a peeling apparatus according to the related art.

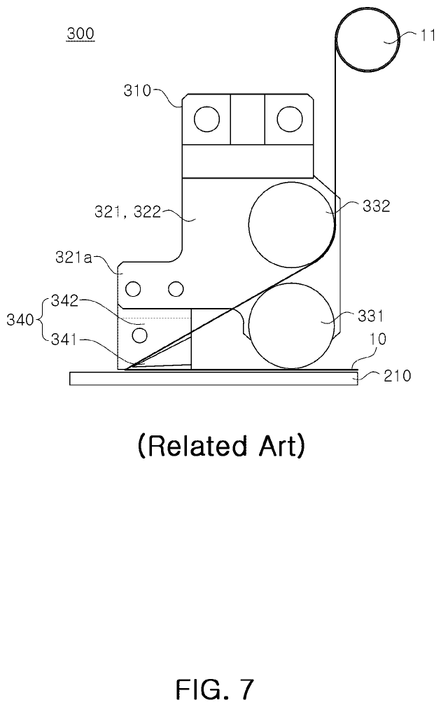

FIG. 7 is a schematic plan view, viewed in direction P1 of FIG. 6, of a peeling method using a peeling apparatus according to the related art.

Referring to FIG. 6, a peeling apparatus 300 according to the related art may include cases 321 and 322 accommodating first and second rolls 331 and 332 spaced apart from each other, and a peeling structure 340 connected to a protrusion portion 321a of the case. In this case, the peeling structure 340 according to the related art may include a body 341 having a triangular pillar shape. The peeling apparatus 300 according to the related art may include a support portion 310 that may be connected to an external facility or device, and the peeling structure 340 may include a connection portion (body 341) connected to the protrusion portion 321a of the case.

Referring to FIG. 7, the carrier film 10 attached to the laminated bar 210 may be peeled according to pressure applied by the body 341 of the peeling structure 340, and the carrier film 10, peeled by the pressure applied by the body 341, may be wound onto a third roll 11 as the first and second rolls 331 and 332 rotate in opposite directions.

Referring to FIG. 7, a method of peeling the carrier film 10 from the laminated bar 210 using the peeling apparatus 300 in the related art may involve the triangular prism-shaped body 341 of the peeling structure 340 directly applying pressure to the carrier film 10. In this case, one edge of the triangular prism has a small curvature radius of 0.5 mm to 1.0 mm, which may increase the peeling angle of the carrier film 10 from the laminated bar 210. When the peeling force of the carrier film 10 increases, the stress applied to the surface of the laminated bar 210 may also increase. An increase in the surface stress of the laminated bar 210 may, when the laminated bar 210 undergoes subsequent processes to form an MLCC 100, cause A/C delamination in the MLCC 100 or result in peeling of the cover portions 112 and 113 of the MLCC 100.

Referring to FIG. 7, the peeling structure 340 may be connected to a protrusion portion 321a of one of the cases, 321 or 322, such that a peeling angle of the carrier film 10 may be different for each position, and a vertical distance between the carrier film and the peeling structure 340 may also be different for each position. In addition, a connection structure in which the peeling structure 340 is connected to the one protrusion portion 321a of each of the cases 321 and 322 may cause sagging due to a weight of the peeling structure 340 itself, thereby increasing a vertical distance between the peeling structures 340 and causing an increase in the peeling angle of the carrier film 10.

In order to minimize stress applied to the laminated bar 210, it may be desirable for the peeling angle of the carrier film 10 to be close to 0°. However, due to a structure of the peeling apparatus, which needs to apply pressure to specific regions of the carrier film 10, it may be impossible to maintain a peeling angle of 0° while performing peeling. Accordingly, there is a need for an improved peeling apparatus and a peeling method, capable of minimizing stress applied by the carrier film 10 to the laminated bar 210, during a peeling process in which pressure is applied using the peeling apparatus.

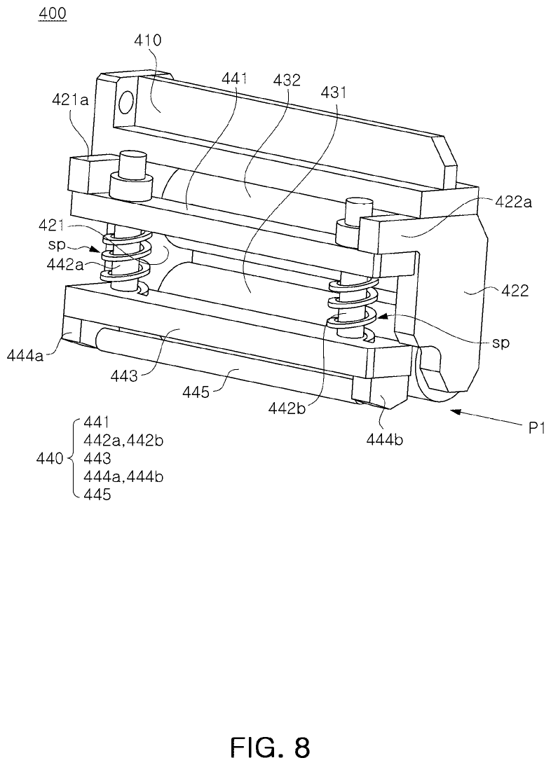

FIG. 8 is a schematic perspective view of a peeling apparatus according to an example embodiment of the present disclosure.

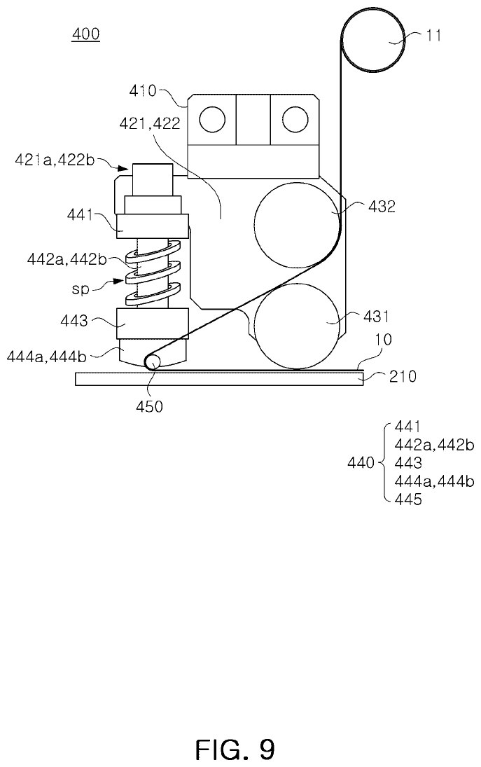

FIG. 9 is a schematic plan view, viewed in direction P1 of FIG. 8, of a peeling method using a peeling apparatus according to an example embodiment of the present disclosure.

Referring to FIGS. 8 and 9, a peeling apparatus 400 according to an example embodiment of the present disclosure may include cases 421 and 422 including a first roll 431 and a second roll 432, and a peeling structure 440 connected to protrusion portions 421a and 422a of the cases 421 and 422.

The peeling structure 440 according to the example embodiment of the present disclosure may include connection portions 441, 442a, 442b, 443, 444a, and 444b connected to the protrusion portions 421a and 422a of the cases, and a cylindrical body 445 rotatably connected to the connection portions 441, 442a, 442b, 443, 444a, and 444b. The connection portions 441, 442a, 442b, 443, 444a, and 444b may include an elastic body sp having a length changing according to linear movement of the cylindrical body 445.

The cylindrical body 445 may apply pressure directly to a carrier film 10 attached to a laminated bar 210, thereby peeling the carrier film 10 from the laminated bar 210.

The cylindrical formation of the cylindrical body 445 may serve to minimize a gap with the carrier film 10 according to a radius of curvature thereof, thereby reducing a peeling angle of the carrier film 10. In addition, the elastic body sp may change in length according to external force resulting from the linear movement of the cylindrical body 445, thereby maintaining uniform pressure applied to the carrier film 10.

That is, the peeling apparatus 400 according to the example embodiment of the present disclosure may include the peeling structure 440 including the connection portions 441, 442a, 442b, 443, 444a, and 444b connected to the protrusion portions 421a and 422a of the cases, and the cylindrical body 445 rotatably connected to the connection portions 441, 442a, 442b, 443, 444a, and 444b. The connection portions 441, 442a, 442b, 443, 444a, and 444b may include an elastic body sp having a length changing according to the linear movement of the cylindrical body 445, thereby reducing the peeling angle of the carrier film 10 attached to a laminate, such as the laminated bar 210, and reducing stress applied to a surface of the laminated bar 210.

Referring to FIG. 9, in the present disclosure, a process of peeling the carrier film 10 from the laminated bar 210 is described, but the present disclosure is not limited thereto, and the above description may be applied to peeling of a film substrate such as the carrier film 10 or a protective film attached to various laminated members other than the laminated bar 210 in the same manner.

In an example embodiment, the connection portions 441, 442a, 442b, 443, 444a, and 444b may include a plurality of elastic bodies sp connected to each other in parallel, thereby preventing sagging caused by a weight of the peeling structure 340, occurring in peeling apparatus 400 according to the related art. Accordingly, a distance between the peeling apparatus 400 and the carrier film 10 may be minimized, and pressure applied to the carrier film 10 may be uniformly adjusted for each position of the cylindrical body 445.

The cases 421 and 422 may accommodate the first roll 431 and the second roll 432, and specifically, may be connected to both ends of the first roll 431 and second roll 432 spaced apart from each other.

The cases 421 and 422 may be separated from each other, but the present disclosure is not limited thereto. When the cases 421 and 422 are separated from each other, the separated cases 421 and 422 may be connected to each other by a support portion 410 to maintain rigidity.

A method in which the first roll 431 and the second roll 432 are connected to the cases 421 and 422 is not limited, and the first roll 431 and the second roll 432 may be coupled to be rotatable within the cases 421 and 422 through a bearing.

In an example embodiment, the cases 421 and 422 may include a plurality of protrusion portions 421a and 422a, and the connection portions 441, 442a, 442b, 443, 444a, and 444b may be connected to the plurality of protrusion portions 421a and 422a.

A material of each of the cases 421 and 422 and the first and second rolls 431 and 432 are not limited. For example, the cases 421 and 422 and the first and second rolls 431 and 432 may each be formed of a metal material, a resin material, or a combination of a metal material and a resin material.

The peeling structure 440 may be physically connected to the cases 421 and 422, and may serve to apply direct pressure to the carrier film 10.

The peeling structure 440 may form a connection structure for connection with the protrusion portions 421a and 422a of the cases 421 and 422. In an example embodiment, the connection portions 441, 442a, 442b, 443, 444a, and 444b of the peeling structure 440 may include a first connection portion 441 integrally connected to the plurality of protrusion portions 421a and 422a, a plurality of second connection portions 442a and 442b connected to a plurality of points of the first connection portion 441, a third connection portion 443 integrally connected to the plurality of second connection portions 442a and 442b, and fourth connection portions 444a and 444b protruding from both sides of the third connection portion 443 and connected to both ends of the cylindrical body 445.

The first connection portion 441 may be integrally connected to the plurality of protrusion portions 421a and 422a, and the third connection portion 443 may be integrally connected to the plurality of second connection portions 442a and 442b, thereby maintaining rigidity of the peeling structure 440. The plurality of second connection portions 442a and 442b may serve to absorb pressure applied from the carrier film 10 and allow the cylindrical body 445 to apply uniform pressure to the carrier film 10.

The plurality of second connection portions 442a and 442b may include an elastic body sp to absorb pressure applied from the carrier film 10. The elastic body sp may be disposed on a surface of a member capable of length extension, but the present disclosure is not limited thereto, and the plurality of second connection portions 442a and 442b themselves may be formed of the elastic body sp.

The type of the elastic body sp is not limited. In an example embodiment, the elastic body sp may include one or more of a urethane spring, a gas spring, or a steel spring.

The cylindrical body 445 may be a component applying pressure directly to the carrier film 10, and may apply uniform pressure to the carrier film 10 through line contact. Uniform pressure may be applied to the carrier film 10 for each position due to the elastic body having a length changing according to the linear movement of the cylindrical body 445. According to pressure applied by the cylindrical body 445 to the carrier film 10, the carrier film 10 may be peeled from the laminated bar 210.

The shape of the cylindrical body 445 is not limited. However, in order to apply pressure to the carrier film 10 or maintain rigidity during rotation, the cylindrical body 445 may have a solid cylindrical shape.

A material of the cylindrical body 445 is not limited. However, in order to apply pressure to the carrier film 10 or maintain rigidity during rotation, the cylindrical body 445 may be formed of a metal having excellent mechanical strength. Specifically, the cylindrical body 445 may be formed of stainless steel.

An average radius of curvature of the cylindrical body 445 may be 2.5 mm or more and 3.0 mm or less. Accordingly, a gap between the cylindrical body 445 and the carrier film 10 may be minimized, thereby further reducing a peeling angle of the carrier film 10. Here, the average radius of curvature of the cylindrical body 445 may refer to an average value of radii of curvature measured from the outside in a circumferential direction at three or more equally spaced points in a length direction of the cylindrical body 445, but the present disclosure is not limited thereto. A radius gauge may be used to measure the radius of curvature. Other methods and/or tools appreciated by one of ordinary skill in the art, even if not described in the present disclosure, may also be used.

The cylindrical body 445 may be rotatably connected to a connection portions, more specifically, the fourth connection portions 444a and 444b, and the cylindrical body 445 and the fourth connection portions 444a and 444b may be coupled to each other through a bearing.

In an example embodiment, a hardness of the cylindrical body 445 may be HRC37 or more and HRC43 or less (Rockwell hardness C scale). Accordingly, damage caused by friction with the bearing during rotation of the cylindrical body 445 may be prevented. The hardness may be measured by an indenter. Other methods and/or tools appreciated by one of ordinary skill in the art, even if not described in the present disclosure, may also be used.

In an example embodiment, the peeling apparatus 400 may include a support portion 410 that may be connected to an external facility or device, and accordingly, a position of the peeling apparatus 400 relative to the carrier film 10 may be adjusted. Specifically, the support portion 410 of the peeling apparatus 400 may be connected to a driving unit to move on the carrier film 10 in a vertical and horizontal directions.

Referring to FIG. 9, the carrier film 10 attached to the laminated bar 210 may be peeled according to pressure applied by the cylindrical body 445 of the peeling structure 440, and the carrier film 10, peeled by the pressure applied by the cylindrical body 445, may be wound onto the third roll 11 as the first roll 431 and the second roll 432 rotate in opposite directions.

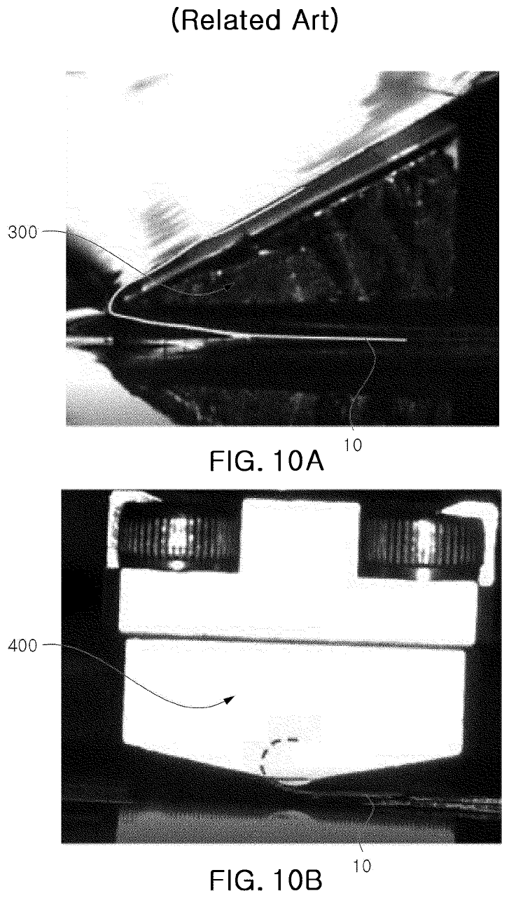

FIG. 10A is an image obtained by capturing a carrier film peeled from a laminated bar using a peeling apparatus according to the related art, and FIG. 10B is an image obtained by capturing a carrier film peeled from a laminated bar using a peeling apparatus according to an example embodiment of the present disclosure; and

Referring to FIG. 10A, when a carrier film 10 is peeled using a peeling apparatus 300 according to the related art, it may be confirmed that a vertical interval is formed between the peeling apparatus 300 and the carrier film 10, and it may also be confirmed that a peeling angle of the carrier film 10 forms a gentle obtuse angle. Conversely, when a carrier film 10 is peeled using a peeling apparatus 400 according to an example embodiment of the present disclosure, it may be confirmed that a vertical interval between the peeling apparatus 400 and the carrier film 10 is reduced, and that a peeling angle of the carrier film 10 is also slightly reduced.

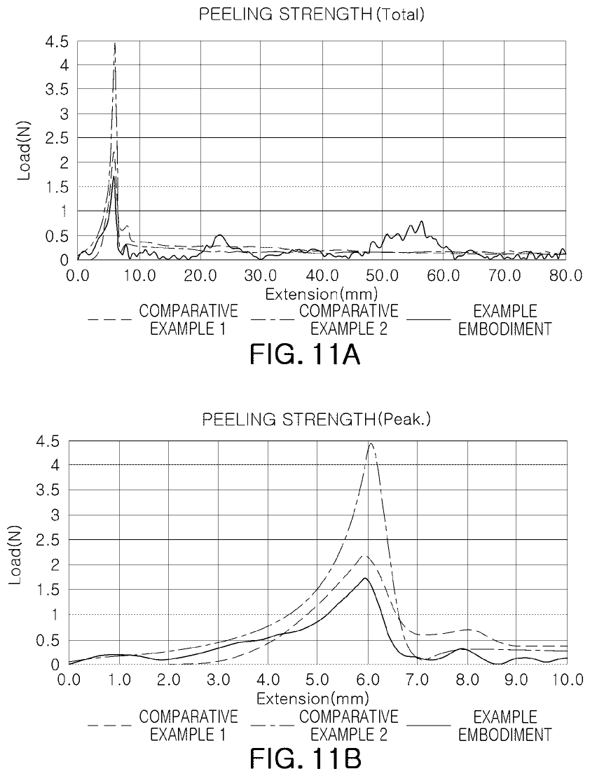

FIG. 11A and FIG. 11B are graphs illustrating results of measuring peeling strength when peeling of a carrier film is performed using a peeling apparatus according to the related art, and when peeling of a carrier film is performed using a peeling apparatus according to an example embodiment of the present disclosure.

Comparative Example 1 is a case in which a peeling angle was maintained at 150 degrees using a peeling apparatus according to the related art, and Comparative Example 2 is a case in which a peeling angle was maintained at 150 degrees using a peeling apparatus according to the related art, and a vertical interval between the peeling apparatus and a carrier film in actual use was assumed to be 5 mm. The peeling angles in Comparative Examples 1 and 2 were set to 150 degrees based on the fact that, in the peeling apparatus according to the related art, when an angle of an edge of a body having a triangular pillar shape that is in contact with the carrier film is 30 degrees, an actual peeling angle is formed to be about 150 degrees.

The example embodiment may be a result of measuring peeling strength using the peeling apparatus according to an example embodiment of the present disclosure.

Referring to FIG. 11A and FIG. 11B, it may be confirmed that, in the case of Comparative Example 1, a peak peeling strength at a peeling front end was 2.2 N, and in the case of Comparative Example 2, it may be confirmed that a peak peeling strength at a peeling front end was 4.4 N, indicating an increase, and in the case of the example embodiment, it may be confirmed that a peak peeling strength at a front end was improved to 1.7 N.

That is, as in an example embodiment of the present disclosure, when a peeling structure 440 includes connection portions 441, 442a, 442b, 443, 444a, and 444b connected to protrusion portions 421a and 422a of a case, and a cylindrical body 445 rotatably connected to the connection portions 441, 442a, 442b, 443, 444a, and 444b, and when the connection portions 441, 442a, 442b, 443, 444a, and 444b includes an elastic body sp having a length changing according to linear movement of the cylindrical body 445, it may be confirmed that, when peeling a film substrate attached to a laminated member such as a laminated bar, stress applied to the laminated member may be reduced.

### Experimental Example

The table below shows results of measuring and comparing of a peeling probability of a cover portion, where a case of manufacturing an MLCC using a peeling apparatus according to the related art is defined as a comparative example, and a case of manufacturing an MLCC using a peeling apparatus according to an example embodiment of the present disclosure is defined as an example embodiment.

TABLE 1

| | Number of | Cover |
|---|---|---|
| Category | Tests | Portion Peeling |
| Comparative Example | 117 | 0.22% |
| Example Embodiment | 123 | 0.15% |

Referring to Table 1, it may be confirmed that a peeling probability of a cover portion is reduced in the example embodiment as compared to the comparative example. Accordingly, in the case of the example embodiment, it may be confirmed that stress applied to the cover portion during carrier film peeling may be minimized.

While example embodiments have been shown and described above, it will be apparent to those skilled in the art that modifications and variations could be made without departing from the scope of the present disclosure as defined by the appended claims.

In addition, the term “an example embodiment” used herein does not refer to the same example embodiment, and is provided to emphasize a particular feature or characteristic different from that of another example embodiment. However, example embodiments provided herein are considered to be able to be implemented by being combined in whole or in part one with one another. For example, one element described in a particular example embodiment, even if it is not described in another example embodiment, may be understood as a description related to another example embodiment, unless an opposite or contradictory description is provided therein.

The terms used herein are for the purpose of describing particular example embodiments only and are to not be limiting of the example embodiments. As used herein, the singular forms “a,” “an,” and “the” are intended to include the plural forms as well, unless the context clearly indicates otherwise.

What is claimed is:

1. A peeling apparatus comprising:
a case accommodating a first roll and a second roll; and
a peeling structure connected to the case,
wherein the peeling structure includes:
a connection portion connected to a protrusion portion of the case, and
a cylindrical body rotatably connected to the connection portion, and
the connection portion includes an elastic body having a length that changes according to linear movement of the cylindrical body.

2. The peeling apparatus of claim 1, wherein the elastic body includes a plurality of elastic bodies connected to each other in parallel.

3. The peeling apparatus of claim 1, wherein the protrusion portion of the case includes a plurality of protrusion portions,
the connection portion further includes:
a first connection portion integrally connected to the plurality of protrusion portions of the case;
a plurality of second connection portions, each second connection portion being connected to a corresponding point among a plurality of points of the first connection portion;
a third connection portion integrally connected to the plurality of second connection portions; and
a fourth connection portion protruding from sides of the third connection portion and connected to ends of the cylindrical body.

4. The peeling apparatus of claim 1, wherein an average radius of curvature of the cylindrical body is 2.5 mm or more and 3.0 mm or less.

5. The peeling apparatus of claim 1, wherein the cylindrical body is a solid cylinder.

6. The peeling apparatus of claim 1, wherein the cylindrical body has a hardness of HRC37 or more and HRC43 or less.

7. The peeling apparatus of claim 1, wherein the elastic body includes one or more selected from the group consisting of a urethane spring, a gas spring, and a steel spring.

8. A peeling method of peeling a carrier film attached to a laminated bar comprising:
applying pressure to the carrier film utilizing a peeling apparatus including a cylindrical body,
wherein the peeling apparatus includes:
a case accommodating a first roll and a second roll; and
a peeling structure connected to the case,
the peeling structure includes:
a connection portion connected to a protrusion portion of the case, and
a cylindrical body rotatably connected to the connection portion, and
the connection portion includes an elastic body having a length that changes according to linear movement of the cylindrical body.

9. The peeling method of claim 8, wherein the elastic body includes a plurality of elastic bodies connected to each other in parallel.

10. The peeling method of claim 8, wherein the protrusion portion of the case includes a plurality of protrusion portions,
the connection portion further includes:
a first connection portion integrally connected to a corresponding point among a plurality of protrusion portions of the case;
a plurality of second connection portions connected to a plurality of points of the first connection portion;
a third connection portion integrally connected to the plurality of second connection portions; and
a fourth connection portion protruding from sides of the third connection portion and connected to ends of the cylindrical body.

11. The peeling method of claim 8, wherein an average radius of curvature of the cylindrical body is 2.5 mm or more and 3.0 mm or less.

12. The peeling method of claim 8, wherein the cylindrical body is a solid cylinder shape.

13. The peeling method of claim 8, wherein the cylindrical body has a hardness of HRC37 or more and HRC43 or less.

14. The peeling method of claim 8, wherein the elastic body includes one or more selected from the group consisting of a urethane spring, a gas spring, and a steel spring.

15. The peeling method of claim 8, further comprising moving the peeling apparatus on the carrier film.

16. The peeling method of claim 15, wherein the peeling apparatus is moved on the carrier film in a vertical direction, a horizontal direction, or both.

17. The peeling method of claim 8, wherein the laminated bar includes a plurality of dielectric layers and a plurality of internal electrode patterns.
